(19) United States
(12) Patent Application Publication
(10) Pub. No.: US 2016/0076755 A1
(43) Pub. Date: Mar. 17, 2016

(54) Heat Sink for Solid State Lamps

(71) Applicant: Richard Ham, Irvine, CA (US)

(72) Inventor: Richard Ham, Irvine, CA (US)

(21) Appl. No.: 14/484,591

(22) Filed: Sep. 12, 2014

(51) Int. Cl. F21V 29/74

(52) U.S. Cl. CPC F21V 29/74

(57) ABSTRACT

A heat sink of compact design that allows for direct mounting of solid state lights such as LED arrays to the heat sink, while providing a physical arrangement that maximizes the surface area available for effective heat dissipation, is provided. The heat sink of the present invention features a hollow, polyhedral core body and an outer structure comprised of a plurality of mounting surfaces for solid state lights. The outer structure is generally in the form of a tapered polyhedron with relieved cutouts at the corners to form a plurality of triangular shaped heat transfer structures. The outermost wall of each triangular shaped heat transfer structures comprises the mounting surface for an array of solid state

### FIELD OF THE INVENTION

The present invention relates generally to the field of solid state lamps, and more particularly to improved heat sinks for use in solid state lamps utilizing a plurality of LED arrays operating at high wattages.

### BACKGROUND OF THE INVENTION

Solid state lighting systems utilizing LEDs are now gaining favor for use in a variety of applications including general indoor and outdoor area lighting of industrial and warehouse facilities, as well as area lighting of homes and garages, among a growing list applications. Lighting systems utilizing LED arrays offer a longer lasting, more efficient alternative to conventional light sources such as incandescent, fluorescent and halogen light sources.

The operational power of many current LED lamps is often limited however, by the LED lamp's ability to dissipate heat. More particularly, increasing the current of an LED lamp increases the amount of heat generated by the lamp. Beyond a certain point, this excess heat generated becomes detrimental to the performance of an LED lamp and may result in reduced performance and/or operational life of the individual LEDs which comprise the lamp and may potentially cause early failure of the LEDs. Accordingly, increasing the ability of a solid state lamp to dissipate beat allows for higher power, and thus brighter, LED lamps.

To achieve the above-described operational benefits, heat sinks are typically used in LED based lighting systems. The heat sinks provide a means for absorbing the heat generated by the LEDs in the lighting assembly, and for dissipating the heat via convection or radiantly to the surrounding atmosphere.

Heat sink design is of particular importance in LED lamps, because LED lamps designed for area lighting require a large number of LEDs to generate sufficient light output. The LEDs must also be packaged within a limited physical space, i.e. LED lamps must typically be of about the same size as the conventional lamps they replace. In addition, typically all of the LEDs in a lamp are driven at the same time, which requires that a heat sink be able to dissipate large amounts of heat on a continuous basis. It is common in commercial applications for LED lamps to be operated continuously throughout a typical work day or to provide area illumination throughout the night.

Some heat sinks used in LED lamps feature a radial pattern of closely spaced metal fins to dissipate heat. Heat sinks of this type, are disadvantageous in that it is not possible to directly mount LED arrays to the metal fins of the heat sinks. Therefore, LED lamps which use radial fin style heat sinks require a separate mounting pad or plate upon which are mounted the LED arrays and this mourning pad or plate in turn must interface with the heat sink. This results in increased component costs, weight and size. Other LED lamp designs have, attempted to integrate or mount the LED arrays directly on the heat sink. However, the few such designs which presently exist appear to have insufficient surface area to support large LED arrays operating at high wattages as is required to generate sufficient light to illuminate large areas.

Accordingly, there is a need in the art for an improved heat sink for use in LED lamps. Such an improved heat sink should include provisions for directly mounting LED arrays to the heat sink, yet should also feature a large surface area for convectively and radiantly dissipating the heat generated by large LED arrays operating at high wattages.

### SUMMARY OF THE INVENTION

A heat sink for solid state lamps which solves many of the problems of the prior art is provided. The heat sink of the present invention provides a compact design that allows for direct mounting of solid state lights such as LED arrays to the heat sink, while providing a physical arrangement that maximizes the surface area available for effective heat dissipation.

A preferred embodiment of the heat sink of the present invention features a hollow, polyhedral core body and an outer structure comprised of a plurality of mounting surfaces or pads for solid state lights. The outer structure is generally in the form of a tapered polyhedron with relieved areas or cutouts at the corners to form a plurality of triangular shaped heat transfer structures. The outermost wall of each triangular heat transfer structure comprises the mounting surface or pad for an array of solid state lights. Each triangular heat transfer structure is relieved in its interior about an interior wall or heat transfer plate that interconnects the center of the solid state lighting mounting surface with the a corresponding wall of the core.

The interior of the hollow core, the interior wall or heat transfer plates, and the exteriors of the side walls of the triangular heat transfer structures may feature cooling fins or ribs to maximize the surface area for convective and radiative heat transfer.

Due to the tapered design of the heat sink, substantially more mass is located at the upper end of the heat sink that at the lower end. This arrangement is believed to produce a temperature gradient along the length of the core of the heat sink, with the upper end of the core being relatively cooler than the lower end of the core The temperature gradient produced therein is believed to create an air flow-through effect where heated air tends to flow through the core in response to the temperate gradient. Therefore, when the core is hot due to the heat transferred by the solid state lights, cool air is drawn into the upper end of the core and is subsequently expelled from the lower end. The air flow-through effect increases the cooling efficiency of the cooling fins in the core.

### BRIEF DESCRIPTION OF THE DRAWINGS

FIG. 1 is a perspective view of a solid state light, incorporating an embodiment of the heat sink of the present invention.

FIG. 2 shows a top perspective view of the heat sink of FIG. 1.

FIG. 3 shows a bottom perspective view of the heat sink of FIG. 2.

FIG. 4 shows perspective sectional view of the heat sink of FIG. 2, taken along the line A-A of FIG. 2.

FIG. 5 shows a side elevational view of the heat sink of FIG. 2.

FIG. 6 shows a top plan view of the heatsink of FIG. 2.

FIG. 7 shows a bottom plan view of the heat sink of FIG. 2.

FIG. 8 is a sectional perspective view of the heat sink of FIG. 2, taken along line B-B of FIG. 5.

FIG. 9 is a bottom perspective view of an alternative mbodiment of the heat sink of the present invention.

FIG. 10 is top perspective view of the alternative embodiment of the heat sink of FIG. 9.

FIG. 11 is a side elevational view of the alternative embodiment of the heat sink of FIG. 9.

FIG. 13 is a top plan view of the alternative embodiment of the heat sink of FIG. 9.

FIG. 14 is a sectional perspective view of the heat sink of FIG. 9, taken along line C-C of FIG. 11.

### DETAILED DESCRIPTION OF THE INVENTION

The following detailed description refers to the accompanying drawings that show, by way of illustration, specific details and embodiments in which the invention may be practiced.

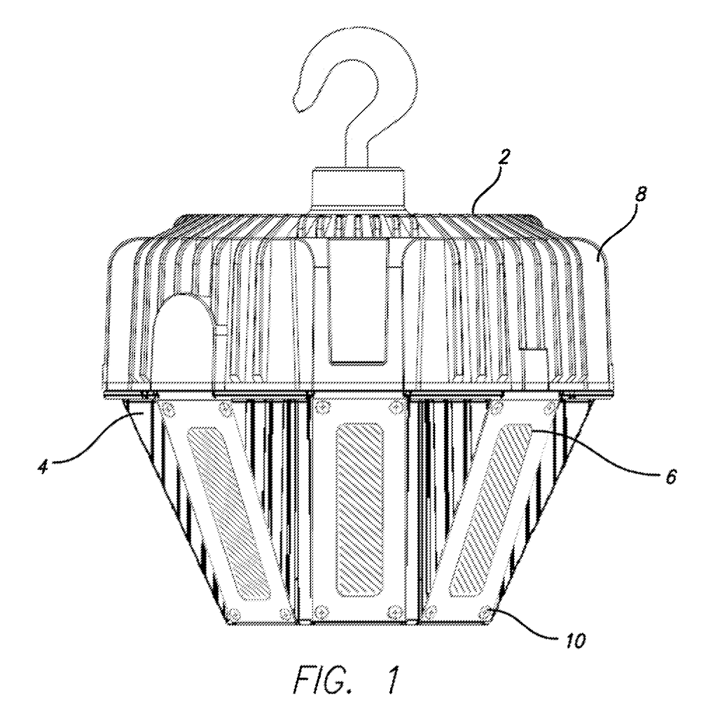

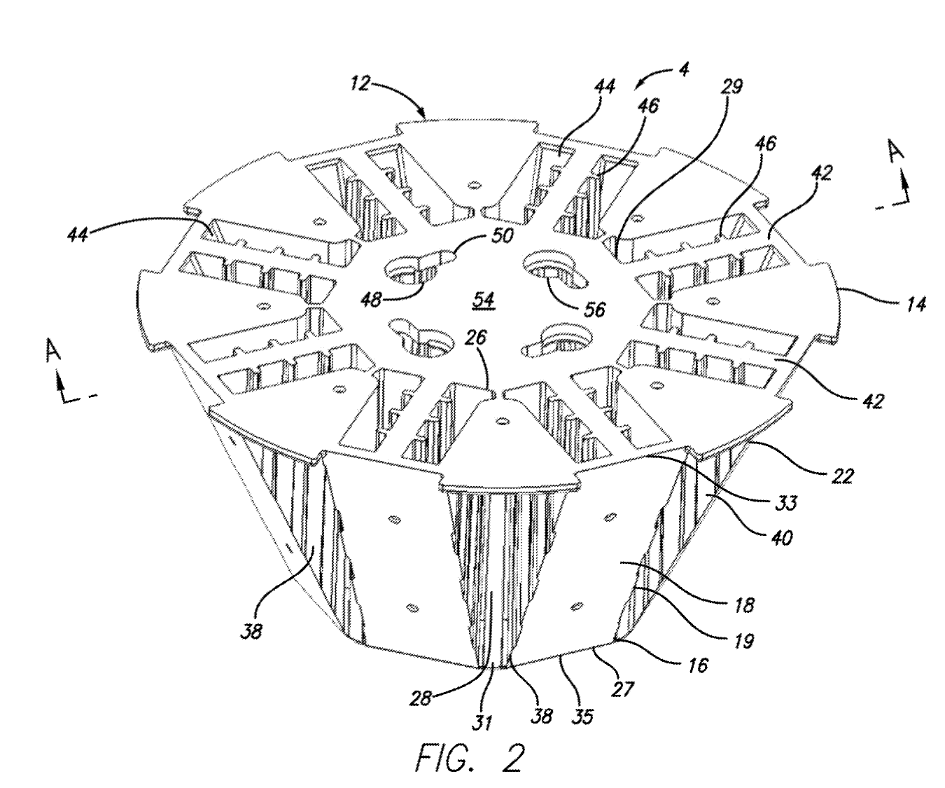

Referring now to FIG. 1, a solid state lamp 2 in accordance with the present invention is shown. The solid state lamp 2 comprises a heat sink 4, solid state lights 6 affixed to the heat sink 4, and a power module 8.

In the exemplary embodiment, the solid state lights 6 are arrays of light emitting diodes (“LEDs”). The solid state lights or LEDs are typically attached to the heat sink via fastening means 10. Fastening means 10 may comprise thermally conductive adhesives or mechanical fasteners, as is known in the art.

The power module 8 includes the lamp electronics (not) which typically comprise a step-down AC to DC transformer, an LED driver, and a surge suppressor, and may also include heat sensors and current limiting features, as is known in the art.

The configuration of the lamp 2 of the present invention is not limited to any particular shape for the power module 8. Likewise, the solid state lamp 2 of the present invention is not limited to any particular configuration or type of solid state lights. A wide variety of LED types and array styles are known in the art and are suitable for use with the invention disclosed herein. Nor is the invention limited to the use of LEDs. Other, non-LED based solid state lighting technologies may become commercially viable in the future.

The heat sink 4 of the present invention may be made from most any material with a high coefficient of thermal conductivity. Suitable materials include copper, aluminum, zinc, and alloys thereof, as well as ceramic materials. In the exemplary embodiment, the heat sink 4 is die cast in a single piece. However, this is not a requirement of the design and the heat sink 4 may he manufactured in multiple sections which are subsequently fastened together. Generally, assembly costs are reduced by casting the heat sink as a single piece. Conversely, initial tooling costs may possibly be reduced by assembling the heat sink from separately cast sections.

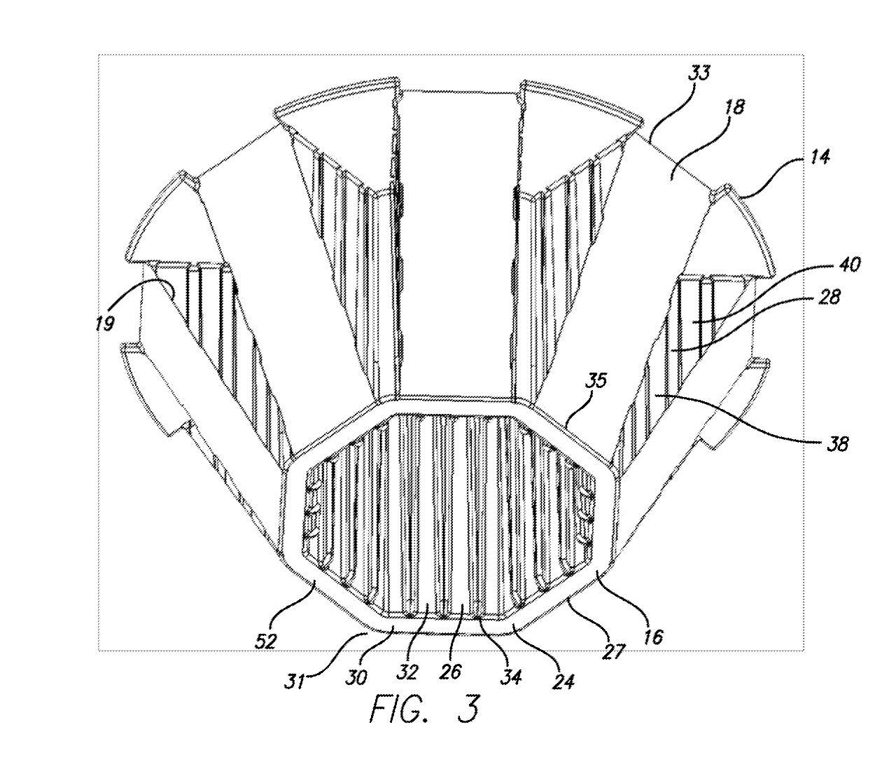

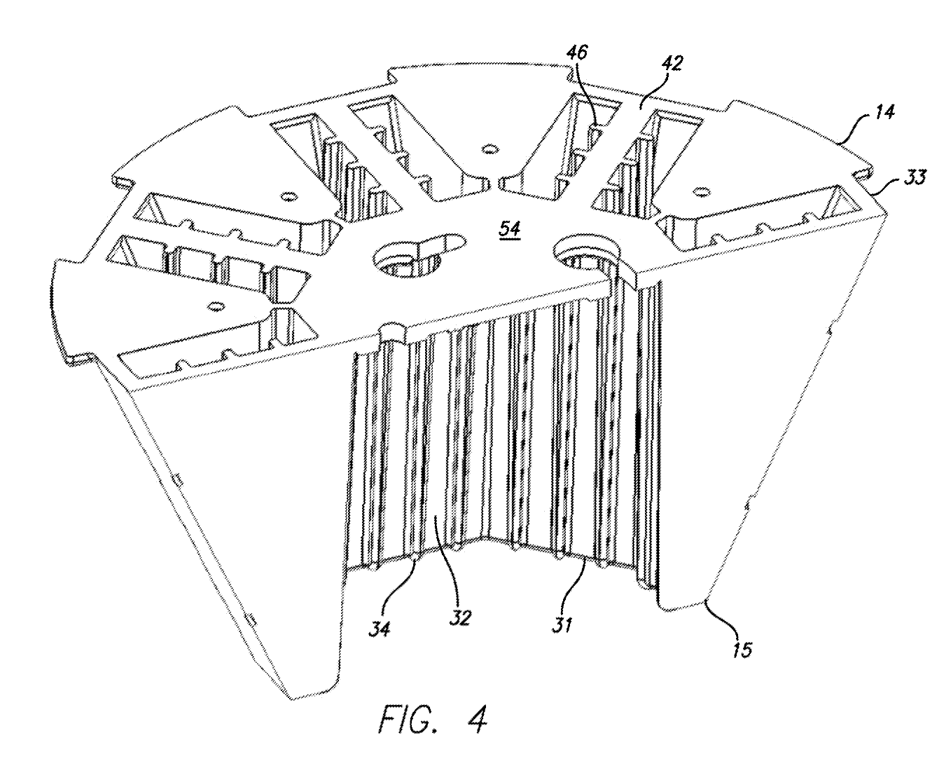

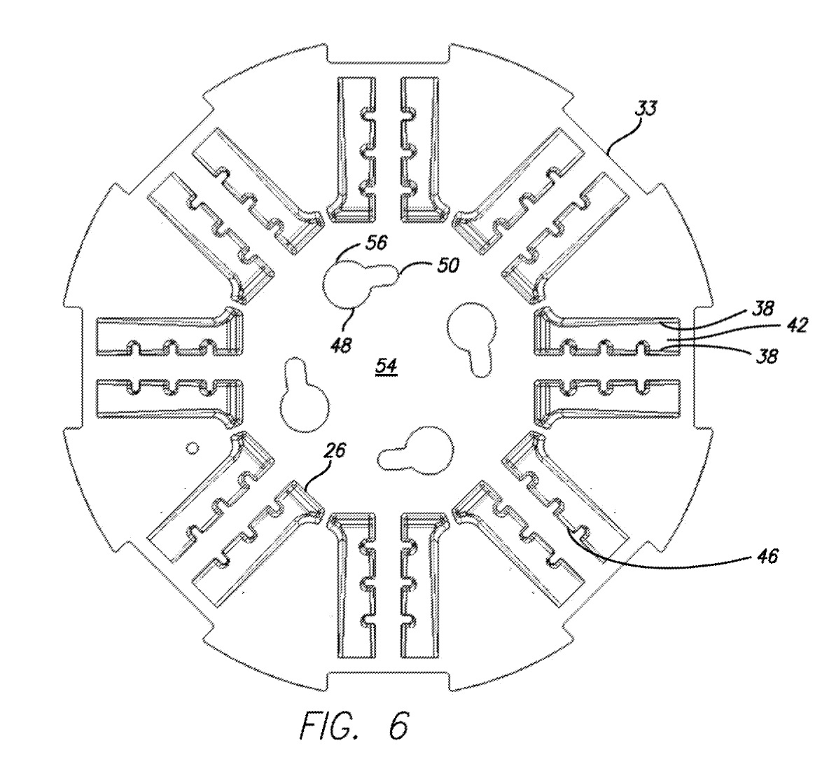

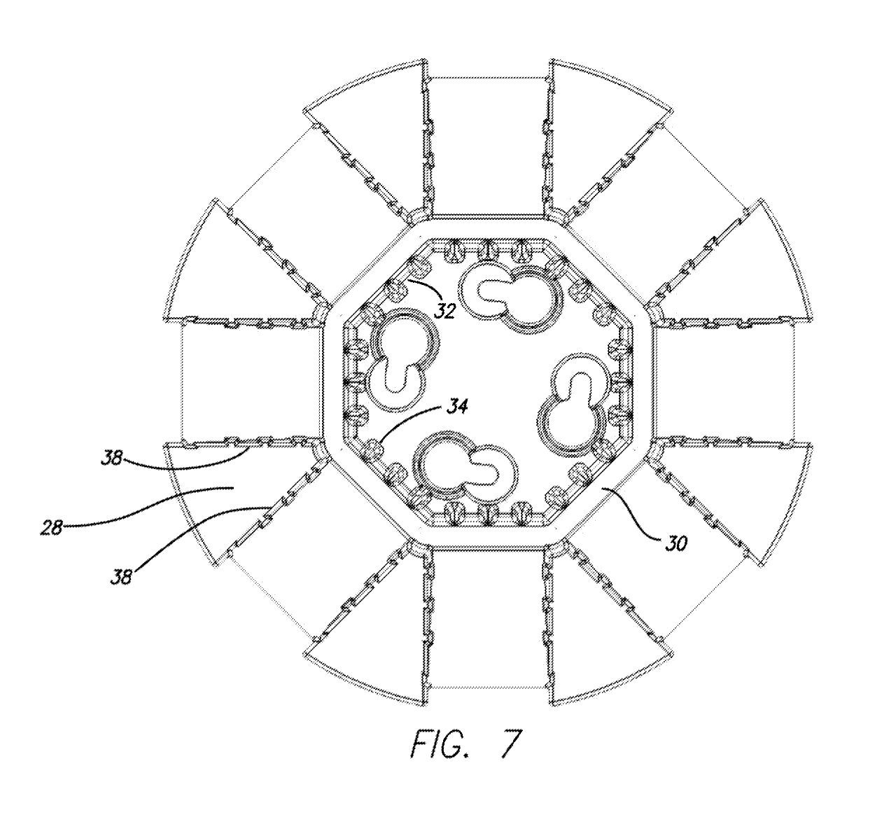

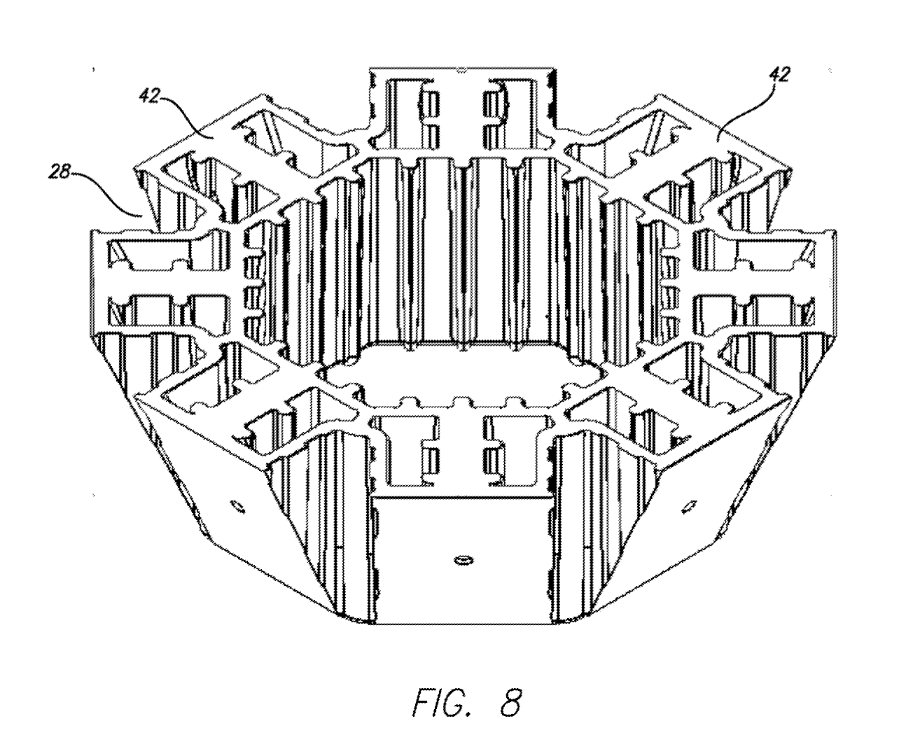

Referring now to FIGS. 2-8, the heat sink of the present invention 4 features a hollow, polyhedral body 12, having an interior polyhedral core 24 and a polyhedral outer structure 22. The hollow core 24 the polyhedral body 12 is a non-tapered polyhedron defined by an upper planer end 14 and a lower planer end 16 and by side walls 26. The side walls 26 of the core have lower 27 and upper 29 outer edges and side edges 31. The lower planer end 16 of the core 24 features an opening 52. The upper planer end 14 of the core 24 features a partially closed upper surface 54. The partially enclosed upper surface 54 of the core 24 includes a plurality of openings 56. The openings 56 include circular holes 48 and adjacent slots 50 extending from the holes 48. The openings 56 allow for the use of fasteners, such as screws, to attach a lamp driver or power module 8 or an additional heat sink to the heat sink 4.

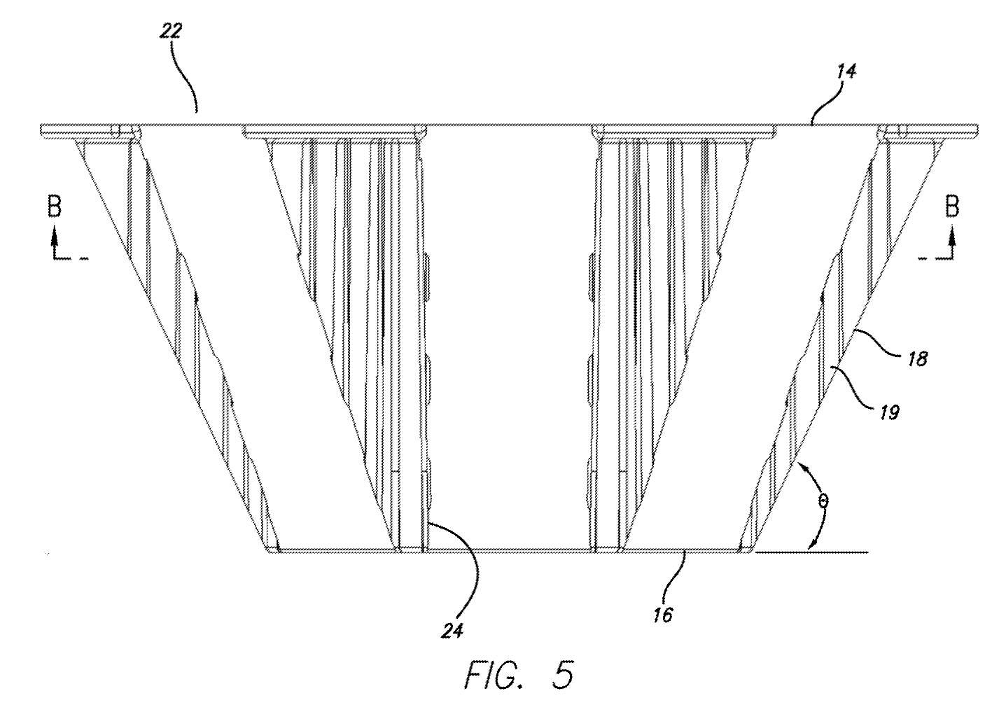

The polyhedral outer structure 22 is generally in the form of a tapered polyhedron with relieved cutouts at the corner regions 28 which form triangular shaped heat transfer structures 19 which extend outwardly from the core 24. The triangular heat transfer structures 19 have a solid state lighting element mounting surface or pad 18, lower and upper edges 35 and 33, and side walls 38. The triangular heat transfer structures 19 of the outer structure 22 of the polyhedral body 12 are defined or bounded by the upper planer end 14 and the lower planer end 16 of the core and by the plurality of angled, planer, solid state light mounting surfaces 18. The angle of the mounting surfaces 18, also referred to as the taper angle of the exterior polyhedral structure 22 of the polyhedral body 12, is defined by an angle theta (see FIG. 5). The inventor has found via experimentation that theta angles within the range of 45 degrees to 75 degrees are particularly well-suited for lighting large areas, with a theta angle of 65 to 67 degrees being optimal for many situations.

The number of walls 26 of the core 24 corresponds to the number of solid state light mounting surfaces 18. The walls 26 of the core 24 have a theta angle of less than two degrees, i.e. the walls 26 of the core 24 may be slightly tapered.

The walls 26 of the core 24 of the polyhedral body 12 are coextensive from the lower planar end 16 to the upper planer end 14 of the core and have a generally uniform thickness 30. Each of the walls 26 of the core 24 have a plurality of longitudinal cooling fins 34 which project inwardly of an interior surface 32 of the walls 26 of the core 24. The fins 34 serve to increase the available surface area in the core and function to cool the core 24 by a combination of convection and radiation of the heat conducted to the core from the solid state light mounting surfaces 18.

In the exemplary embodiment, the number of walls 26 of the core and exterior solid state light mounting surfaces 18 is eight (8). Therefore, the exemplary embodiment of the heat sink 4 has an exterior polyhedral shape 22 in the form of a tapered eight-sided polyhedron, with cutaway corner regions 28, where the degree of taper is defined by the taper angle theta. Eight-sided polyhedrons are also referred to as octagonal prisms. Correspondingly, the interior polyhedral core 24 being also eight-sided, is in the form of octagonal prism.

Although the exemplary embodiment of the heat sink 4 features eight (8) tapered or angled, planer, solid state light mounting surfaces 18 and eight planer core walls 26, the heat sink 4 herein presented may feature a lessor or greater number of core walls and solid state light mounting surfaces to form polyhedral bodies other than tapered octagonal prisms.

As shown in the figures, the solid state light mounting pads 18 do not meet at the corners as would be the case in a solid polyhedral body. Rather, the corner regions 28 of the polyhedral body 12 are relieved to form the triangular heat transfer structures 19. For an n-sided polyhedral body, there are n-number of cutouts or relieved regions 28 and triangular heat transfer structures 19. The exemplary embodiment of the heat sink 4 is an eight-sided polyhedron or octagonal prism, and therefore features eight cutouts or relieved corner regions 28 and triangular heat transfer structures 19.

Each of the triangular heat transfer structures are defined by exterior wal s 38 which include a plurality of cooling ribs 40. The ribs 40 serve to increase the effective surface area of the relieved corner regions 28, which concomitantly increases the ability of the relieved corner regions 28 to dissipate heat by conduction and radiation.

Interconnecting the solid state light mounting pads 1$ with the core 24 are radially aligned interior walls or heat transfer plates 42. The interior walls or heat transfer plates 42 serve as the primary pathway for conducting heat from the solid state light mounting surfaces 18 to the core 24. Adjacent to, and on each side of the interior walls or heat transfer plates 42 are triangular shaped cavities 44 which are relieved in the polyhedral body 12 between the core 24 and the solid state light mounting surfaces 18. The relieved triangular cavities 44 allow for the inclusiin of longitudinal cooling fins 46 spaced along each side of the interior walls or heat transfer plates 42. The cooling fins 46 again function to increase the surface area available to dissipate the heat generated by the solid state lights 6.

In some embodiments of the heat sink design of FIGS. 2-8, the upper end 14 of the core 24 may be open to allow air to freely pass through the core. In such embodiments, an air flow-through effect is believed to occur in the core because the tapered design of the heat sink concentrates mass at one end of the core which is believed, to create a temperature gradient along the length of the core, with the high mass upper end 14 of the core being comparatively cooler than the lower mass, lower end 16 of the core. Heated air being of lower density than cool air tends to flow along the temperature gradient in the core. Therefore, when the core 24 is hot due to the heat transferred by the solid state lights 6, cool air is drawn into the upper end 16 of the core 24 and is subsequently expelled from the lower end 16 of the core.

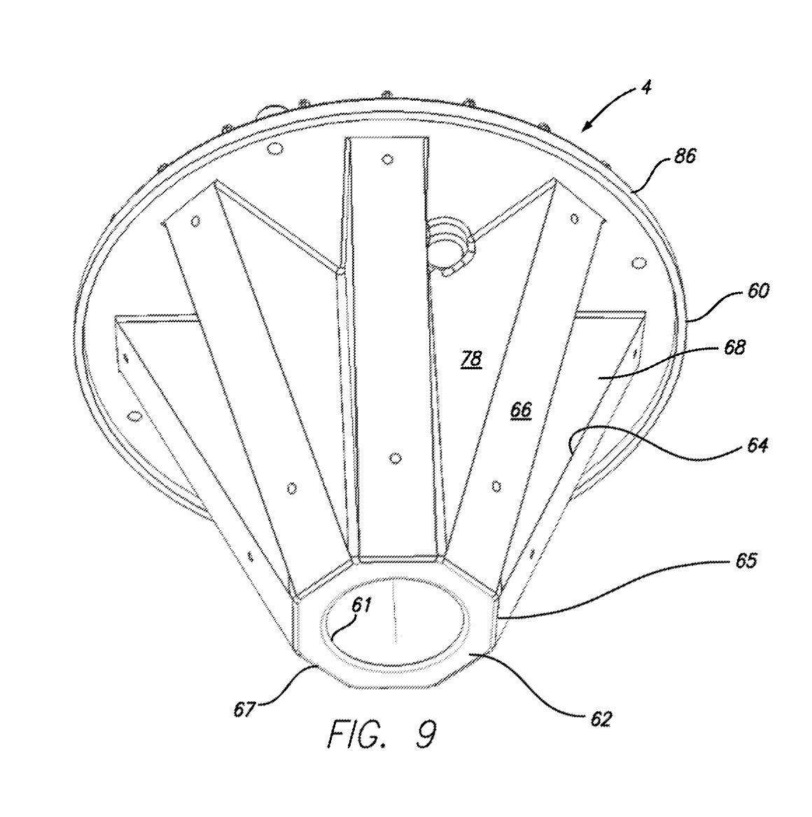

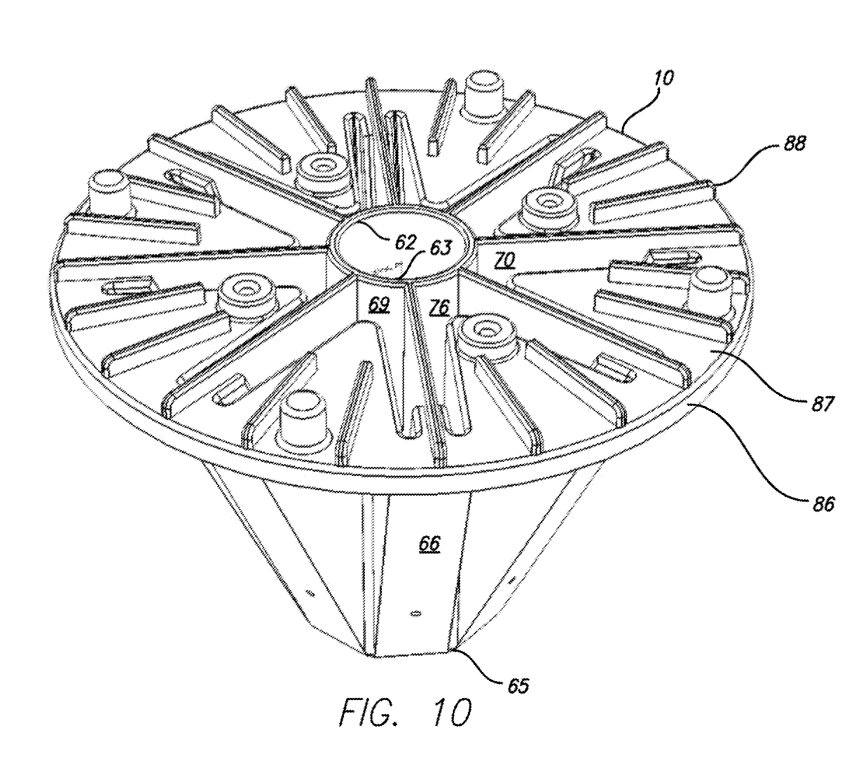

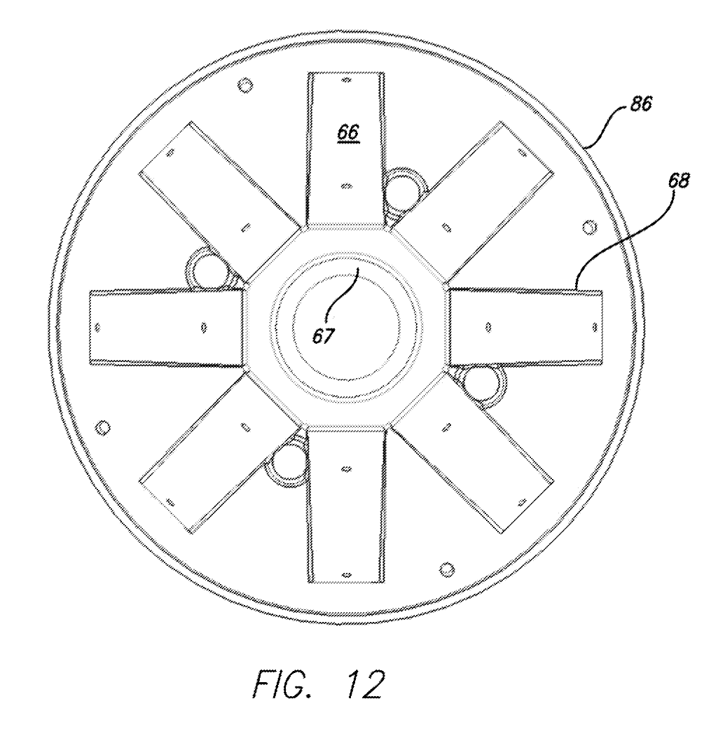

Referring now w to FIGS. 9-12, an alternative embodiment of the heat sink 4 of the present invention is shown. The alternative embodiment features a heat sink body 60 having a hollow cylindrical core 62. The hollow cylindrical core 62, having an inner wall 61 and an outer wall 67, and an upper end 63 and a lower end 65. Extending radially outwardly from the core 62 are a plurality of triangular heat transfer structures 64. Each triangular heat transfer structure 64 features a mounting surface or pad 66 for solid state lights such as .LED arrays. The mourning surfaces for solid state lights 66 are angled outwardly from the core at an inclination angle theta (see FIG. 11). Experimentation has shown that theta angles within the range of 45 degrees to 75 degrees are particularly well-suited to lighting, large areas, with a theta angle of 65 to 67 degrees being optimal for many situations.

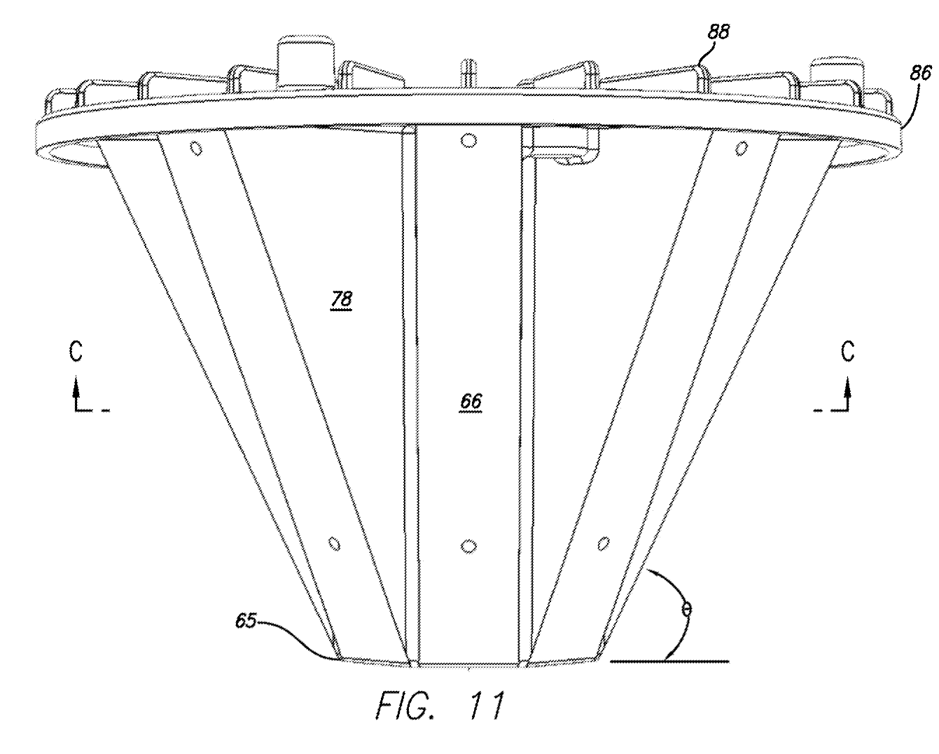

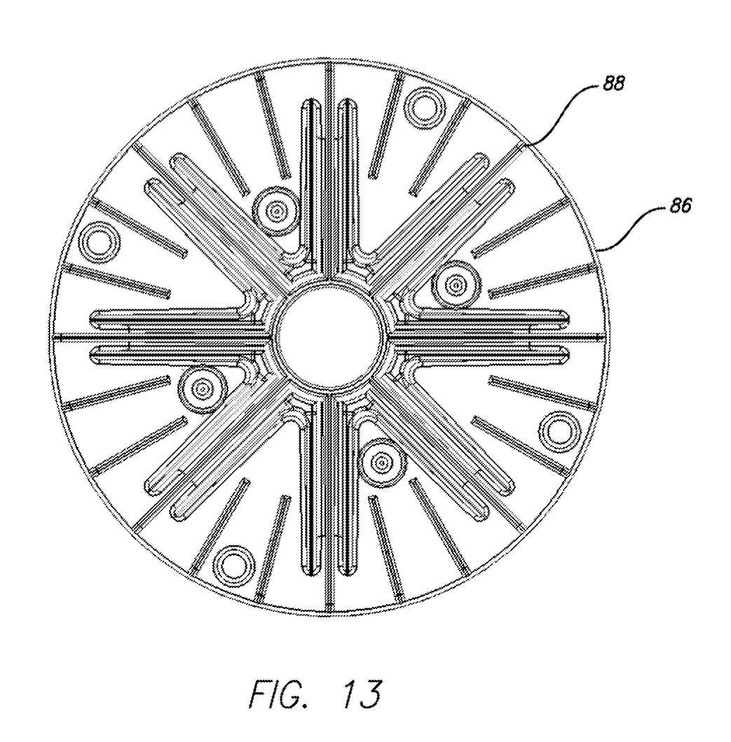

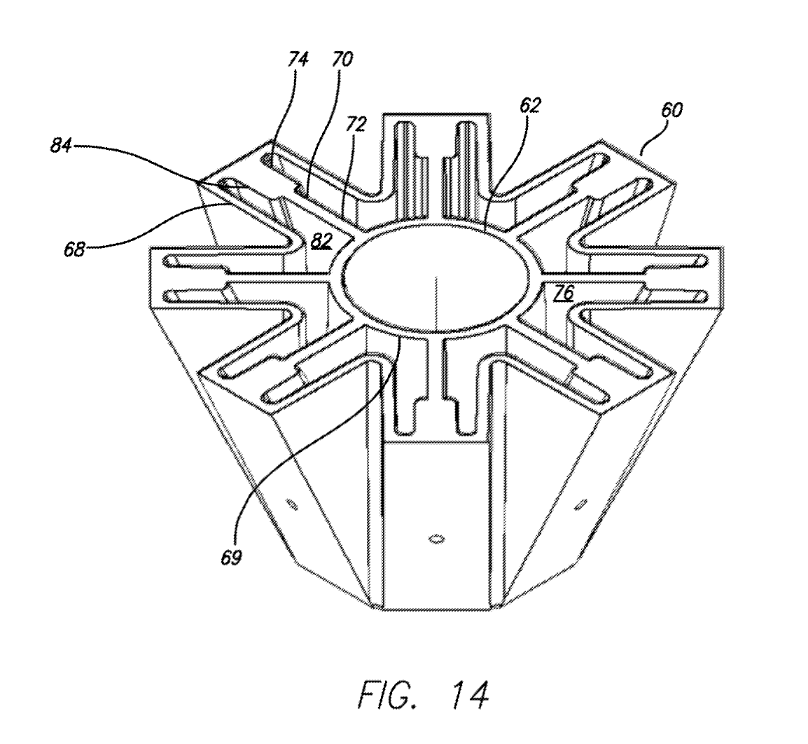

Referring now in particular to FIGS. 10 and 14, the heat sink 4 of the embodiment of FIGS. 9-14, increases the e surface area of the heat sink exposed to air, and thus provides for increased cooling capacity, by providing the triangular heat. transfer structures 64 with outer walls 68 and interior walls 70. The outer walls 68 have exterior surfaces 78 and interior surfaces 80. Both the interior surfaces 80 and exterior surfaces 78 of the walls 68 are exposed to air and therefore the walls 68 may dissipate heat via convection and radiation from both of the surfaces 78 and 80. The inner walls 70 also have exposed to air surfaces 82 and 84, on each side of each interior wall 70, and therefore can also dissipate heat via convection and radiation. It should be noted that this configuration provides for substantially more surface area for the dissipation of heat than would otherwise be obtainable if the triangular heat transfer structures were solid.

The configuration of the interior walls 70, side walls 68 and solid state light mounting surfaces 66, and outer surface 69 of the wall of the core 67 which comprise the triangular heat transfer structures 64, may also be described as forming a free air space 76 adjacent to each interior wall 70. The free air space 76 extends from the lower end 65 of the core to the top end 63 of the core.

The interior walls 70 have an inner portion 72 and an outer portion 74, wherein, in one embodiment, the outer portion 74 is of greater thickness than the inner portion 72. It is desirable in some embodiments, particularly with regard to high power lighting applications, for the outer portion 74, which is immediately adjacent to the solid state light mounting surface 66 to be of substantial thickness in order to better absorb and transfer heat generated by the solid state lights to adjacent portions of the heat sink.

Experimentation has shown that the inner portion 72 of the interior wail 70 may be of lesser thickness than the outer portion 74 because as the outer portion 74 reaches its heat absorption capacity heat is conducted away from the outer portion 74 via three pathways, i.e. the inner portion 72 of the interior wall 70 and the side walls 68 of the triangular heat transfer structure 64.

It should be noted that the core 62 is hollow and open at both ends. Due to the tapered design of the heat. sink body 62, which concentrates substantially more mass at the top end 63 of the body, it is believed that, when the solid state lights are operating, a temperature gradient will be created along the length of the core 62, with the top end 63 being of comparatively lower temperature than the lower end 65. It is believed that this temperature gradient will create an air flow-through effect in the core wherein air entering the core tends to follow the temperature gradient. The it flow through effect increases the overall efficiency of the heat sink design.

The upper end 63 of the heat sink body 60 also includes a planer disc 86 upon which a plurality of cooling fins 88, are radially spaced about a top surface 87 of the disc, to further increase the surface area available for dissipating heat.

One of skill in the art will appreciate that the present invention presents compact new heat sink designs that allow for the direct mounting of solid state lights such as LED arrays to the heat sink, while providing a physical arrangement that maximizes the surface area available for effective heat dissipation.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention, which do not depart from the spirit and scope of the foregoing specification and drawings, and of the claims appended below, are possible and practical. It is intended that the claims cover all such modifications and alternative embodiments.

What is claimed is:

1. A heat sink for a solid state lamp, comprising:
a polyhedral core having an upper end and a lower end and a plurality of site walls having upper edges and lower edges;
a plurality of solid state lighting element mounting surfaces, each mounting surface having an angled wall with an upper edge, a lower edge and side edges, wherein each of the plurality of mourning surfaces corresponds to one of the plurality of side walls of the polyhedral core, wherein the lower edge of each of the mounting surfaces contacts and is parallel to the lower edge of the corresponding side wall of the core;
wherein each of the plurality of mounting surfaces is angled outwardly from the wall of core at the juncture of the lower edges of the mounting surfaces and the corresponding lower edges of the core; and
wherein a plurality of plate elements, one plate element corresponding to each mounting: surface and to each corresponding wall of the core connects the wall of the mounting surface to the wall of the core.

2. The heat sink for a solid state lamp of claim 1, wherein the core is hollow.

3. The heat sink for a solid state lamp of claim 2, wherein the hollow core has an open lower end.

4. The heat sink for a solid state lamp of claim 2, wherein the hollow core has longitudinal cooling fins spaced about the interior of the core.

5. The heat sink for a solid state lamp of claim 1, wherein the hollow core has an at least partially enclosed upper end.

4. The heat sink for a solid state lamp of claim 1, wherein the plate elements disposed between the core and mountmg surfaces include at least one longitudinal cooling fin.

5. The heat sink for a solid state lamp of claim 1, wherein side wails extend from each side of the polyhedral core to the corresponding side edges of the mounting surfaces.

6. The heat sink for a solid state lamp of claim 5, wherein an exterior surface of each side wall includes at least one cooling fin.

7. A heat sink for dissipating, the heat generated by a plurality of the solid state lighting elements, comprising:
a core in the form of an octagonal prism having an upper end and a lower end and side walls having upper edges and lower edges;
eight solid state lighting element mounting pads, each mounting pad having an angled wall with an upper edge, a lower edge and side edges, wherein each of the eight mounting pads corresponds to one of the eight side walls of the octagonal prism core, wherein the lower edge of each of mounting pad contacts and is parallel to the lower edge of the corresponding side wall of the octagonal prism core;
wherein each of the eight mounting pads is angled outwardly from the wall of core at the juncture of the lower edges of the mounting pads and the corresponding lower edges of side walls of core; and
wherein plate elements, one plate element corresponding to each mounting surface and to each corresponding wail of the core connects the wall of the iounting pad to the wall of the core.

8. The heat sink for a lamp for dissipating the heat generated by a plurality of the solid state lighting elements of claim 7, wherein the core is hollow.

9. The heat sink for a lamp for dissipating the heat generated by a plurality of the solid state lighting elements of claim 8, wherein the hollow core has an open lower end.

10. The heat sink for a lamp for dissipating the heat generated by a plurality of the solid state lighting elements of claim 8, wherein the hollow core has longitudinal cooling fins spaced about the interior of the core.

11. The heat sink for a lamp for dissipating the heat generated by a plurality of the solid state lighting elements of claim 7, wherein the hollow core has an at least partially enclosed upper end.

12. The heat sink for a lamp for dissipating the heat generated by a plurality of the solid state lighting elements of claim 7, wherein the plate elements disposed between the core and mounting pads includes at least one longitudinal cooling fin.

13. The heat sink for a lamp for dissipating the heat generated by a plurality of the solid state lighting elements of claim 7, wherein side walls extend from each side of the polyhedral core to the corresponding side edges of the mounting pads.

14. The heat sink for a lamp for dissipating the heat generated by a plurality of the solid state lighting elements of claim 13, wherein an exterior surface of each side wall includes at least. one cooling fin.

15. A heat sink for a solid state lamp, comprising.
a core having an upper end and a lower end;
a plurality of triangular heat transfer structures, spaced radially about the periphery of the core; and
wherein each of the plurality triangular heat transfer structures includes an outwardly facing solid state light mounting surface disposed at an angle to the core.

16. The heat sink for a solid state lamp of claim 15, wherein the core is hollow.

17. The heat sink for a solid state lamp of claim 15, wherein the core is cylindrical.

18. The heat sink for a solid state lamp of claim 15, wherein the core is a hollow, polyhedral body.

19. The heat sink for a solid state lamp of claim 15, wherein each of the plurality of triangular heat transfer structures includes side walls and a wall interior to to the side walls, wherein the side walls and wall interior to the side walls interconnects the solid state light mounting surface with the core.

20. The heat sink for a solid state lamp of claim 19, wherein a free-air-space is defined by the region between the triangular heat transfer structure side walls, wall interior to the side walls and the wall of the core.
